(19) United States
(12) Patent Application Publication
(10) Pub. No.: US 2016/0165943 A1
(43) Pub. Date: Jun. 16, 2016

(54) STARCH-BASED EGG WHITE EXTENDER IN BAKED FOODSTUFFS

(71) Applicants: Matthew Yurgec, Bridgewater, NJ (US); Dilek Uzunalioglu, Millington, NJ (US); Cristina Munteanu, Broomfield, CO (US)

(72) Inventors: Matthew Yurgec, Bridgewater, NJ (US); Dilek Uzunalioglu, Millington, NJ (US); Cristina Munteanu, Broomfield, CO (US)

(21) Appl. No.: 14/308,127

(22) Filed: Jun. 18, 2014

(51) Int. Cl. A21D 2/18; A23L 1/0522

(52) U.S. Cl. CPC A23L 1/3216; A23L 1/0541; A23L 1/0522; A21D 2/186; A21D 2/185; A23V 2002/00

(57) ABSTRACT

A composition useful as an extender for egg whites in a baked foodstuff comprising a major amount of a potato starch and a minor amount of granular xanthan gum, said granular xanthan gum having a mean particle size greater than 40 micrometers is provided. Also provided is a method of replacing egg whites in a baked foodstuff comprising adding a major amount of a potato starch and a minor amount of granular xanthan gum, said granular xanthan gum having a mean particle size greater than 40 micrometers, to replace a portion of the egg whites in a baked foodstuff. A baked foodstuff comprised of egg whites, wherein at a portion of the egg whites are replaced with a major amount of a potato starch and a minor amount of granular xanthan gum, said granular xanthan gum having a mean particle size greater than 40 micrometers is also provided. It has been found that if xanthan gum of a relatively coarse grind is used as a partial replacement for egg whites to prepare a baked foodstuff, such as an angel food cake, then improved properties of the baked foodstuffs are obtained as compared to the use of xanthan gum of a relatively fine grind.

### BACKGROUND OF THE INVENTION

Egg albumen, or egg whites, are a known food ingredient in a number of foodstuffs, particularly baked foodstuffs, for example angel food cakes. Due to the expense of egg whites, extenders or replacements for egg whites have been developed.

U.S. Pat. No. 4,238,519 (Chang) discloses an egg albumen extender comprised of a protein-containing composition having certain characteristics and other ingredients, including gums such as xanthan, but preferably carrageenan. Xanthan gum, along with water and wheat starch is suggested as a partial replacement for egg whites in angel food cakes by L. L. Miller, et al., “Xanthan Gum in a Reduced Egg White Angel Food Cake”, Cereal Chemistry, 60(1): 62-64 (1983).

### SUMMARY OF THE INVENTION

In one aspect, this invention relates to a composition useful as an extender for egg whites in a baked foodstuff comprising a major amount of a potato starch and a minor amount of granular xanthan gum, said granular xanthan gum having a mean particle size greater than 40 micrometers. In a related embodiment, the composition is further comprised of a minor amount of a dextrin, preferably a white dextrin.

In another aspect, this invention relates to a method of replacing egg whites in a baked foodstuff comprising adding water, a major amount of a potato starch and a minor amount of granular xanthan gum, said granular xanthan gum having a mean particle size greater than 40 micrometers (and preferably a minor amount of a dextrin), to replace a portion of the egg whites in a baked foodstuff.

In another aspect, this invention relates to a baked foodstuff comprised of egg whites, wherein at least a portion of the egg whites are replaced with a major amount of a potato starch and a minor amount of granular xanthan gum, said granular xanthan gum having a mean particle size greater than 40 micrometers (and preferably a minor amount of a dextrin).

It has been found that if xanthan gum of a relatively coarse grind is used as a partial replacement for egg whites to prepare a baked foodstuff, such as an angel food cake, then improved properties of the baked foodstuffs are obtained as compared to the use of xanthan gum of a relatively fine grind.

### DETAILED DESCRIPTION

Potato starch is starch extracted from potatoes. The cells of the root tubers of the potato plant contain starch grains (leucoplasts). In a typical process to extract the starch, the potatoes are macerated or crushed and the starch grains are released from the destroyed cells. The starch is then washed out, collected, and dried to powder. The potato starch is preferably used in its native state, i.e. as isolated from the cells of the potato and after washing and drying. The potato starch may also be starch recovered from aqueous process streams that are the by-product of the processing of potatoes. The starch may be minimally modified prior to use, e.g. physically, thermally or chemically, if desired, but is preferably used in its native state.

Xanthan gum is an extracellular polysaccharide secreted by the micro-organism Xanthomonas campestris. Xanthan gum is soluble in cold water and solutions exhibit highly pseudoplastic flow. The bacterium Xanthomonas campestris produces the polysaccharide at the cell wall surface during its normal life cycle by a complex enzymatic process. Commercially, xanthan gum is typically produced from a pure culture of the bacterium by an aerobic, submerged fermentation process. The bacteria are cultured in a well-aerated medium containing glucose, a nitrogen source and various trace elements. To provide seed for the final fermentation stage, the process of inoculum build-up is carried out in several stages. When the final fermentation has finished the broth is pasteurized to kill the bacteria and the xanthan gum is recovered by precipitation with isopropyl alcohol. Finally, the isolated product is dried to a crude form and the crude form is then milled to form granules. The particle size of the crude xanthan gum can be reduced using milling machines such as the ball mill, vertical roller mill, hammer mill, roller press or high compression roller mill, vibration mill, or jet mill, among others. The particle size of the granules of milled xanthan gum can be adjusted by conventional dry sieving with appropriately sized sieves.

The particle size of the granular xanthan gum is determined by particle analysis using laser diffraction. Laser diffraction analysis depends upon analysis of the “halo” of diffracted light produced when a laser beam passes through a dispersion of particles in air or in a liquid and is based on the Fraunhofer diffraction theory, stating that the intensity of light scattered by a particle is directly proportional to the particle size. The angle of the laser beam and particle size have an inversely proportional relationship, where the laser beam angle increases as particle size decreases and vice versa. A useful particle size analyzer is the LS Particle Size Analyzer, LS 13 320, available from Beckman Coulter, Inc., 250 South Kraemer Boulevard, Brea, Calif. The mean particle size obtained by the use of this apparatus is volume based.

The mean particle size of the granular xanthan gum, as measured by laser diffraction, will be greater than 40 micrometers. Typically, the mean particle size is greater than about 45 micrometers, more typically greater than about 50 micrometers, and even more typically greater than about 60 micrometers. Preferably, the mean particle size is greater than 70 micrometers or about 80 micrometers, more preferably greater than about 90 micrometers, and even more preferably greater than about 100 micrometers. Even more preferred granular xanthan gums have a mean particle size of greater than about 110 micrometers, and even more preferably greater than about 115 micrometers. The mean particle size will typically range from about 100 micrometers to about 200 micrometers, more typically from about 110 micrometers to about 150 micrometers and even more typically from about 115 micrometers to about 125 micrometers.

The granular xanthan gum will typically have a narrow particle size distribution. Typically, the ratio of the mean particle size to median particle size will be less than about 1.5:1, more typically less than about 1.2:1, an even more typically less than about 1.1:1. Preferably, the ratio of the mean particle size to median particle size will be less than about 1.05:1. The granular xanthan gum will typically contain less than about 20%, and more typically less than about 10%, by volume of particles outside the range of from about 100 micrometers to about 200 micrometers, more typically from about 110 micrometers to about 150 micrometers and even more typically from about 115 micrometers to about 125 micrometers, and more typically less than about 5% by volume of particles outside these ranges.

The amounts of potato starch and granular xanthan gum in the compositions of this invention can vary widely, but potato starch will constitute more than 50% by weight of the blend, preferably from about 90% to about 99, more preferably from about 92% to about 96%, and even more preferably from about 93% to about 95%, by weight. Thus, the weight ratio of potato starch to xanthan gum will be greater than 1:1, preferably from about 9:1 to about 99:1, more preferably from about 11.5:1 to 24:1 and even more preferably from about 13:1 to about 19:1.

The compositions of this invention may also contain a dextrin in a minor amount by weight in addition to the major amount of potato starch and minor amount of granular xanthan gum. As used herein, the term “dextrin” means the products made by heating dry starch with or without acid. During the reaction, greater or lesser amounts of hydrolysis, transglycosidation, and repolymerization occur. According to which reaction predominates, the product is a white dextrin, a yellow dextrin, or a British gum. Preferred dextrins are white dextrins, especially those exhibiting low solubility, solution stability and dispersed viscosity. The weight ratio of potato starch to dextrin will typically range from about 1.5:1 to about 6:1, and more typically from about 2:1 to about 4:1, and even more typically from about 2.5:1 to about 3.5:1.

The baked foodstuffs of this invention can be any of a variety of baked goods, including without limitation, cakes, including angel food cake, yellow cake, sponge cake, chiffon cake, cookies, muffins, pancake and waffle mix, gluten free bread, gluten free rolls, gluten free cakes, gluten free muffins, gluten free cookies, and gluten free pancake and waffle mix. Preferred baked foodstuffs include aerated baked goods such as angel food cakes. The baked foodstuff will typically also contain a reduced amount of egg whites, typically from about 20% to about 60% less egg whites, more typically from about 30% to about 50%, less egg whites, and even more typically from about 35% to about 45% less egg whites, by weight. Water is also added to the baked good to compensate for the water contained in the omitted egg whites, in addition to the composition of this invention. It has been found that replacing only a portion of the water present in the omitted egg leads to increased cake height and reduced gumminess compared to replacing all of the water present in the omitted egg whites. Thus, it is advantageous to reduce the amount of water added to compensate for the omitted egg whites by from about 5% to about 35%, more typically from about 10% to about 30%, and even more typically from about 15% to about 25%, based on the weight of the water present in the omitted egg whites.

The baked foodstuff will also typically be comprised of wheat flour, and may also contain other ingredients typically used in baked goods such as sweeteners, food acids (e.g. cream of tartar), leavening agents, flavorings such as vanilla, and water. The amount of wheat flour in relation to the amounts of egg whites and the composition of this invention in the baked foodstuffs of the invention will vary depending upon the specific nature of the baked foodstuff, but the ratios of wheat flour to egg whites to starch/gum composition will generally range from about 2-60:0.5-2:1, more typically from about 3-50:0.75-1.50:1, and even more typically from about 4-45:0.85-1.3:1, by weight.

The baked foodstuff may also contain other starch-based ingredients. One such ingredient is a dextrin, e.g. a tapioca dextrin, which will aid in forming a stable emulsion in a batter. The dextrin is typically added in an amount of from about 0.5% to 5% by weight, more typically from about 1% to about 2% by weight, of the baked foodstuff formulation. The dextrin may be present in the formulation as a result of pre-blending with the potato starch and granular xanthan gum.

The following examples will serve to illustrate the invention and should not be construed to limit the invention, unless otherwise provided in the appended claims.

### EXAMPLES

### Procedure for Making Angel Food Cake

Angel food cake was prepared using a 20 quart Hobart 3-speed mixer. Reconstituted egg whites were made by mixing egg white powder (12%, plus assuming egg white powder has 10% moisture) and distilled water (88%) with a whisk until particulates of egg white powder is no longer visible and allowing to hydrate for at least 1 hour with periodic mixing. Reconstituted egg whites were then added to mixing bowl with vanilla extract and formula water. Temperature of this mixture was measured to be between 62 and 72° F. Using a whisk Hobart mixer attachment, the mix was mixed for 2 minutes at Speed 2. Part A (sugar plus cream of tartar) was then added and the mixture was continued to be foamed for 11 minutes (foam checked after 7 minutes for consistency). The temperature of the foam was measured to be between 64-74° F. A specific gravity of the foam was also taken and measured to be between 0.12-0.18. Part B (remaining dry ingredients) were then added to the foam in three parts. The mixer was turned on for a very short time after each part was added at speed 1 to hydrate the ingredients (approximately 5-7 seconds). The temperature and specific gravity was measured again and recorded. The angel food cake complete batter was then added to tube angel food cake pans (with detachable bottom) to 800 grams cake weight, and the batter was smoothed with a plastic bowl scraper to make the surface of the batter even and flat. The cakes were then baked in a MIWE electric conduction oven (available from MIWE Michael Wenz GmbH) for 43 minutes at 350° F. The MIWE oven has a heated top and bottom slab (both were on medium setting) and the vent system was assured be closed during baking. After baking, the cakes were taken out of the oven and then flipped over for cooling for approximately 1 hour. The cakes were then taken out of their pans and continued to be cooled to completion for another 30 minutes. The cakes were then packaged into 2-gallon re-sealable plastic bags and then placed into a deep freezer immediately. Prior to running any further analysis, the cakes were thawed.

### Cake Height Measurement:

Angel food cakes were thawed for approximately 24 hours prior to taking measurement. Cake height of the angel food cake was done using digital calipers by measuring the cake at four points (each 90° apart) at the outside of the cake ring, the inside of the cake ring, and the middle point of the cake ring. The diameter of the ring was also taken at four points. An average was taken from the four points measured and recorded as the dimension of the cake.

### Instrumental Texture Analysis of Angel Food Cake:

Angel food cakes were thawed for approximately 6 hours prior to taking measurement. Instrumental texture analysis of the angel food cake was done by using a TPA procedure using a TA-XT Plus (StableMicrosystems, Scarsdale, N.Y.) Texture Analyzer.

The following Texture Analyzer setting was used:

Pre-test Speed: 1 mm/s,

Test Speed: 5 mm/s),

Post-test speed: 5 mm/s

Compress to % Strain

Percent Strain: 50%

Trigger force: 5 g

Delay time between compressions: 5 seconds.

1 inch cylinder acrylic probe used

Texture properties that were recorded include hardness, springiness, resilience, cohesiveness, and gumminess and were calculated using the Stable Microsystems software. Hardness value was the peak force experienced during the first compression of the product (Units in grams). The Cohesiveness value was measured by the area under the curve of the second compression divided by the area under the curve of the first compression (no units). Resilience value was calculated by measuring by dividing the area under the curve of the withdrawal of the first compression divided by the area under the curve of the downstroke of the first compression (not units). Springiness was calculated by the detected height of the product on the second compression divided by the detected height of the product of the first compression (no units). Gumminess value was calculated by multiplying hardness by cohesiveness value (units in grams).

The starches used in the examples are described in Table 1, below.

TABLE 1

| Starch | | |
|---|---|---|
| Number | Starch Name and Manufacturer | Description |
| 1 | NOVATION ® 1900 starch, available | Dry thermally inhibited potato starch, 20% Max |
| | from Ingredion, 10 Finderne Ave., | Moisture, 250-550 MVU viscosity |
| | Bridgewater, New Jersey | |
| 2 | PURAMYL ™ HF 6% starch, available | Lower moisture spec potato starch, Less than |
| | from Avebe, Prins Hendrikplein 20 | 8% moisture |
| | 9641 GK Veendam | |
| | The Netherlands | |
| 3 | ELIANE ™ 100 starch, available from | Waxy Potato Starch, 20.5% moisture (max) |
| | Avebe | |
| 4 | AVEBE ®NS 450 starch, available from | Physically modified native potato starch, 18.5-20% |
| | Avebe | moisture, 1900 BU viscosity, less than 71 |
| | | deg C. peak viscosity temp |
| 5 | Regular Wheat Starch, available from | Native Regular Wheat Starch |
| | MGP Ingredients, 100 Commercial | |
| | Street, Atchison, Kansas | |
| 6 | Waxy Wheat Starch, available from | Native Waxy Wheat Starch |
| | MPG Ingredients | |
| 7 | WESTARCH ™ 100, available from | Native potato starch, less than 20% moisture, |
| | Western Polymer, Moses Lake, WA | 500-122 BU viscosity |

### Examples 1-5 and Comparative Examples A-H

The amounts of the ingredients used in making the angel food cakes and properties of the resulting cakes are shown in Tables 2 and 3, below.

TABLE 2

| Example | A | 1 | B | 2 | C | 3 | D | 4 | 5 |
|---|---|---|---|---|---|---|---|---|---|
| Starch Number | 1 | 1 | 2 | 2 | 3 | 3 | 4 | 4 | 4 |
| Starch Source | Potato | Potato | Potato | Potato | Potato | Potato | Potato | Potato | Potato |
| Part A | Wt. % | Wt. % | Wt. % | Wt. % | Wt. % | Wt. % | Wt. % | Wt. % | Wt. % |
| Sugar (Part A) | 20.55 | 20.55 | 20.55 | 20.55 | 20.55 | 20.55 | 20.55 | 20.55 | 20.55 |
| Cream of Tartar | 0.51 | 0.51 | 0.51 | 0.51 | 0.51 | 0.51 | 0.51 | 0.51 | 0.51 |
| Part B | | | | | | | | | |
| Sugar (Part B) | 20.55 | 20.55 | 20.55 | 20.55 | 20.55 | 20.55 | 20.55 | 20.55 | 20.55 |
| Cake Flour | 16.29 | 16.29 | 16.29 | 16.29 | 16.29 | 16.29 | 16.29 | 16.29 | 16.29 |
| Salt | 0.18 | 0.18 | 0.18 | 0.18 | 0.18 | 0.18 | 0.18 | 0.18 | 0.18 |
| Starch¹ | 3.42 | 3.42 | 3.42 | 3.42 | 3.42 | 3.42 | 3.42 | 3.42 | 3.42 |
| Tapioca Dextrin² | 1.14 | 1.14 | 1.14 | 1.14 | 1.14 | 1.14 | 1.14 | 1.14 | 1.14 |
| Xanthan Gum - | 0.2 | 0 | 0.2 | 0 | 0.2 | 0 | 0.2 | 0 | 0 |
| Fine Grind³ | | | | | | | | | |
| Xanthan Gum - | 0 | 0.2 | 0 | 0.2 | 0 | 0.2 | 0 | 0.2 | 0.2 |
| Coarse Grind³ | | | | | | | | | |
| Part C | | | | | | | | | |
| Reconstituted | 26.21 | 26.21 | 26.21 | 26.21 | 26.21 | 26.21 | 26.21 | 26.21 | 26.21 |
| Egg Whites | | | | | | | | | |
| Vanilla Extract | 0.51 | 0.51 | 0.51 | 0.51 | 0.51 | 0.51 | 0.51 | 0.51 | 0.51 |
| Water | 10.43 | 10.43 | 10.43 | 10.43 | 10.43 | 10.43 | 10.43 | 10.43 | 10.43 |
| TOTAL | 100 | 100 | 100 | 100 | 100 | 100 | 100 | 100 | 100 |
| Cake Height (mm) | 53.75 | 64.28 | 55.13 | 63.03 | 55.35 | 64.47 | 56.00⁴ | 65.38 | 60.06 |
| Cake Hardness | 1460 | 972 | 1346 | 1172 | 1465 | 1094 | 1349⁵ | 992 | 1122 |
| Cake Gumminess | 789 | 579 | 824 | 734 | 930 | 679 | 808⁶ | 524 | 686 |

¹See table above for details on starches used.
²Tapioca Dextrin used was CRYSTAL TEX ® 644 dextrin, available from Ingredion.
³Xanthan Gum used was KELTROL ® brand xanthan, CP KELCO, 3100 Cumberland Boulevard, Atlanta, Georgia;
Fine grind had mean particle size of 39.58 micrometers, and Coarse grind had mean particle size of 122.2 micrometers.
⁴Height of 51.99 mm for a second set of replicates.
⁵Hardness of 1558 for a second set of replicates.
⁶Gumminess of 840 for a second set of replicates.

### Conclusions:

The results in Table 2 show that coarse grind xanthan gum performed significantly better as an egg white extender in angel food cake with the tested potato starches than fine grind xanthan gum in terms of cake height, hardness, and gumminess. The cakes with fine grind xanthan gum were significantly harder, had a lower cake height, and were gummier.

TABLE 3

| | Positive | Negative | | | | |
|---|---|---|---|---|---|---|
| Example | Control | Control | E | F | G | H |
| Starch Number | — | — | 5 | 5 | 6 | 6 |
| Starch Source | — | — | Wheat | Wheat | Wheat | Wheat |
| Part A | Wt. % | Wt. % | Wt. % | Wt. % | Wt. % | Wt. % |
| Sugar (Part A) | 20.10 | 20.52 | 20.55 | 20.55 | 20.55 | 20.55 |
| Cream of Tartar | 0.50 | 0.51 | 0.51 | 0.51 | 0.51 | 0.51 |
| Part B | | | | | | |
| Sugar (Part B) | 20.10 | 20.52 | 20.55 | 20.55 | 20.55 | 20.55 |
| Cake Flour | 15.93 | 16.26 | 16.29 | 16.29 | 16.29 | 16.29 |
| Salt | 0.18 | 0.18 | 0.18 | 0.18 | 0.18 | 0.18 |
| Starch¹ | 0 | 0 | 3.42 | 3.42 | 3.42 | 3.42 |
| Tapioca Dextrin² | 0 | 0 | 1.14 | 1.14 | 1.14 | 1.14 |
| Xanthan Gum - | 0 | 0 | 0.2 | 0 | 0.2 | 0 |
| Fine Grind³ | | | | | | |
| Xanthan Gum - | 0 | 0 | 0 | 0.2 | 0 | 0.2 |
| Coarse Grind³ | | | | | | |
| Part C | | | | | | |
| Reconstituted | 42.70 | 26.16 | 26.21 | 26.21 | 26.21 | 26.21 |
| Egg Whites | | | | | | |
| Vanilla Extract | 0.50 | 0.51 | 0.51 | 0.51 | 0.51 | 0.51 |
| Water | 0.00 | 15.34 | 10.43 | 10.43 | 10.43 | 10.43 |
| TOTAL | 100 | 100 | 100 | 100 | 100 | 100 |
| Cake Height (mm) | 73.06 | 46.50 | 54.93 | 62.09 | 54.53 | 54.25 |
| Cake Hardness | 740 | 1397 | 1308 | 932 | 892 | 1303 |
| Cake Gumminess | 546 | 885 | 784 | 667 | 642 | 822 |

¹See table above for details on starches used.
²Tapioca Dextrin used was CRYSTAL TEX ® 644 dextrin, available from Ingredion.
³Xanthan Gum used was KELTROL ® brand xanthan, CP KELCO, 3100 Cumberland Boulevard, Atlanta, Georgia;
Fine grind had a mean particle size of 39.58 micrometers, and Coarse grind had a mean particle size of 122.2 micrometers.

### Examples 6-8 and Comparative Example I

Traditional yellow layer cakes were made using an egg white extender of the invention.

| | |
|---|---|
| Ingredients | Wt. % |

Part A

| | |
|---|---|
| Sugar | 26.78 |
| Cake Shortening-US DDA Emulsified | 12.28 |

Part B

| | |
|---|---|
| Cake Flour | 23.59 |
| Baking Powder | 0.90 |
| Salt | 0.22 |
| Nonfat Dry Milk | 2.52 |
| Dry Egg Whites | 0.71 |
| Potato or Wheat Starch | 0.51 |
| Xanthan Gum - Coarse Grind | 0.028 |
| Tapioca Dextrin - CRYSTAL TEX ® 644 | 0.17 |

Part C

| | |
|---|---|
| Egg yolk-liquid | 5.25 |

Part D

| | |
|---|---|
| Water | 26.29 |
| Vanilla Extract | 0.75 |
| TOTAL | 100.00 |

A control yellow cake formula is below:

| | |
|---|---|
| Ingredients | Wt. % |

Part A

| | |
|---|---|
| Sugar | 26.78 |
| Cake Shortening-US DDA Emulsified | 12.28 |

Part B

| | |
|---|---|
| Cake Flour | 23.59 |
| Baking Powder | 0.90 |
| Salt | 0.22 |
| Nonfat Dry Milk | 2.52 |
| Dry Egg Whites | 1.41 |

Part C

| | |
|---|---|
| Egg yolk-liquid | 5.25 |

Part D

| | |
|---|---|
| Water | 26.29 |
| Vanilla Extract | 0.75 |
| TOTAL | 100 |

The cakes were manufactured by following the steps below:

### Preparation:

1. Sift together all of the dry ingredients (B). Set aside.
2. Cream the shortening and sugar (A) together in a Hobart N50 mixer at Speed 1 for 1.5 minutes and Speed 2 for 1.5 minutes
3. Add the eggs gradually while mixing at Speed 1. After all eggs are incorporated, mix at Speed 1 for 30 seconds, then Speed 2 for 1.5 minutes.
4. Blend the water and vanilla (D) together.
5. Alternately add A and liquid in 3 parts at Speed 1. Scrape bowl. Mix for additional 1.5 minutes at Speed 2
6. Stop mixing when batter is uniform. Do not overmix.
7. Pour batter into a 8-inch cake pan and bake for 27 minutes @350° F. 500 grams per pan in a conduction oven

### Results:

TABLE 4

| | Starch | | Cake | |
|---|---|---|---|---|
| Example | Number | Starch Name | Height | Sensory Description |
| 6 | 4 | AVEBE ® NS | 44 mm | Firm Bite, Slightly |
| | | 450 | | cohesive in mouth |
| | | | | after initial chew. |
| | | | | Very good |
| | | | | crumb structure |
| 7 | 2 | PURAMYL ® | 46 mm | More chewy and firm. |
| | | HF 6% | | More cohesive |
| 8 | 7 | WESTARCH ™ | 43 mm | Less firm than |
| | | 100-Western | | AVEBE ® NS 450, |
| | | Polymer | | slightly cohesive |
| I | 5 | Regular Wheat | 44 mm | Least firm of all |
| | | Starch | | samples, slightly drier |
| | | | | than rest |

All yellow cakes made generated a cake height that were similar. They also had a crumb structure that were similar to a control yellow cake. They all were slightly cohesive, with the exception of the PURAMYL™ starch that was more cohesive than the rest. The Regular Wheat starch was also slightly drier than the rest.

### Examples 9-11 and Comparative Example J

Muffins were made using the following formulas:

TABLE 5

| | Positive | Negative | | | | |
|---|---|---|---|---|---|---|
| Example | Control | Control | 9 | 10 | J | 11 |
| Ingredients | Wt. % | Wt. % | Wt. % | Wt. % | Wt. % | Wt. % |
| All Purpose Flour | 27.92 | 29.03 | 28.587 | 28.587 | 28.587 | 28.587 |
| Sugar | 17.79 | 17.79 | 17.79 | 17.79 | 17.79 | 17.79 |
| Baking Powder | 1.49 | 1.49 | 1.49 | 1.49 | 1.49 | 1.49 |
| Salt | 0.23 | 0.23 | 0.23 | 0.23 | 0.23 | 0.23 |
| Milk Powder- | 2.23 | 2.23 | 2.23 | 2.23 | 2.23 | 2.23 |
| nonfat, hi-heat | | | | | | |
| Shortening | 11.86 | 11.86 | 11.86 | 11.86 | 11.86 | 11.86 |
| Whole eggs- | 8.9 | 4.45 | 4.45 | 4.45 | 4.45 | 4.45 |
| Liquids | | | | | | |
| Starch No. 4 | 0 | 0 | 0.801 | 0 | 0 | 0 |
| (Potato) | | | | | | |
| Starch No. 7 | 0 | 0 | 0 | 0.801 | 0 | 0 |
| (Potato) | | | | | | |
| Starch No. 5 | 0 | 0 | 0 | 0 | 0.801 | 0 |
| (Wheat) | | | | | | |
| Starch No. 2 | 0 | 0 | 0 | 0 | 0 | 0.801 |
| (Potato) | | | | | | |
| Dextrin¹ | 0 | 0 | 0.267 | 0.267 | 0.267 | 0.267 |
| Xanthan Gum - | 0 | 0 | 0.045 | 0.045 | 0.045 | 0.045 |
| Coarse Grind² | | | | | | |
| Water | 19.13 | 22.47 | 21.8 | 21.8 | 21.8 | 21.8 |
| Blueberries | 9.91 | 9.91 | 9.91 | 9.91 | 9.91 | 9.91 |
| Vanilla Extract | 0.54 | 0.54 | 0.54 | 0.54 | 0.54 | 0.54 |
| Total | 100 | 100 | 100 | 100 | 100 | 100 |

¹Tapioca Dextrin used was CRYSTAL TEX ® 644 destrin, available from Ingredion.
²Xanthan Gum used was KELTROL ® brand xanthan, CP KELCO, with a mean particle size of 122.2 micrometers.

### Results:

TABLE 6

| Example | Starch | Height | Sensory Description |
|---|---|---|---|
| Positive | — | 53 mm | Good crumb structure, firm, slightly dry |
| Control | | | |
| Negative | — | 49 mm | Slightly shorter, cohesive and |
| Control | | | gummy and wet in mouth |
| 9 | No. 4 | 50 mm | Slightly cohesive, gummy after chewdown |
| 10 | No. 7 | 49 mm | Less cohesive than Example 9 |
| J | No. 5 | 52 mm | Drier than all samples, somewhat |
| | | | crumbly and less cohesive |
| 11 | No. 2 | 51 mm | Very cohesive and firmer. Dense and wet |

All muffins were of similar height and were slightly shorter than control. All samples had good crumb structure with some slight tunneling.

What is claimed is:

1. A composition useful as a replacement for egg whites in a baked foodstuff comprising a major amount of a potato starch and a minor amount of granular xanthan gum, said granular xanthan gum having a mean particle size greater than 40 micrometers.

2. The composition of claim 1, wherein the mean particle size is greater than about 45 micrometers.

3. The composition of claim 1, wherein the mean particle size is greater than about 110 micrometers.

4. The composition of claim 1, wherein the mean particle size is from about 100 micrometers to about 200 micrometers.

5. The composition of claim 1, wherein the ratio of mean particle size to median particle size is less than about 1.5:1.

6. The composition of claim 1, wherein the weight ratio of potato starch to granular xanthan gum is from about 9:1 to about 99:1.

7. The composition of claim 1, further comprising a minor amount of a dextrin.

8. A method of replacing egg whites in a baked foodstuff comprising adding water, a major amount of a potato starch and a minor amount of granular xanthan gum, said granular xanthan gum having a mean particle size greater than 40 micrometers, to replace a portion of the egg whites in a baked foodstuff.

9. The method of claim 8, wherein the mean particle size is greater than about 45 micrometers.

10. The method of claim 8, wherein the mean particle size is greater than about 100 micrometers.

11. The method of claim 8, wherein the mean particle size is from about 100 micrometers to about 200 micrometers.

12. The method of claim 8, wherein the ratio of mean particle size to median particle size is less than about 1.5:1.

13. The method of claim 8, wherein the weight ratio of potato starch to granular xanthan gum is from about 9:1 to about 99:1.

14. The method of claim 8, wherein the amount of water added is a portion of the amount of water present in the omitted egg whites.

15. The method of claim 8, wherein the amount of water added from about 10% to about 30% less than the amount of water present in the omitted egg whites.

16. The method of claim 8, further comprising adding a dextrin.

17. A baked foodstuff comprised of egg whites, wherein at least a portion of the egg whites are replaced with a major amount of a potato starch and a minor amount of granular xanthan gum, said granular xanthan gum having a mean particle size greater than 40 micrometers.

18. The baked foodstuff of claim 17, further comprising a minor amount of a dextrin.

19. A baked foodstuff composition a comprising a minor amount by weight of egg whites, a minor amount by weight of potato starch, and a minor amount by weight of granular xanthan gum, said granular xanthan gum having a mean particle size greater than 40 micrometers

20. A composition useful as a replacement for egg whites in a baked foodstuff comprising a potato starch, a granular xanthan gum, said granular xanthan gum having a mean particle size greater than about 100 micrometers and a ratio of mean particle size to median particle size of less than about 1.5:1, and a white dextrin, wherein the weight ratio of potato starch to granular xanthan gum is from about 9:1 to about 99:1 and the weight ratio of the potato starch to white dextrin is from about 1.5:1 to about 6:1.
